(19) United States
(12) Patent Application Publication
(10) Pub. No.: US 2017/0298665 A1
(43) Pub. Date: Oct. 19, 2017

(54) Door Stopper

(71) Applicant: Byung Kwon Cha, Brooklyn Park, MN (US)

(72) Inventor: Byung Kwon Cha, Brooklyn Park, MN (US)

(21) Appl. No.: 15/490,742

(22) Filed: Apr. 18, 2017

(30) Foreign Application Priority Data
Apr. 19, 2016 (KR) 1020160047637

(51) Int. Cl. E05C 17/54

(52) U.S. Cl. CPC E05C 17/54

(57) ABSTRACT

A wedge-shaped door stopper that includes a lower member including soft elastic material and an upper member including rigid material with high hardness to prevent a bottom surface of the door stopper from slipping along over a floor surface and allows the bottom surface to contact the floor surface firmly with high friction. The upper member is removably coupled to the top surface of the lower member and has a smooth, sloped top surface. When the door stopper is used between the floor surface and a bottom of the door and a force is applied to the door in the direction that the door is closed, the bottom of the door glides up on the sloped top surface of the upper member.

### FIELD

The present invention relates generally to a door stopper, and more specifically techniques for preventing a door from being swung by applying the door stopper between the bottom of the door and a floor surface.

### BACKGROUND

A door stopper is generally applied to the bottom of the door to keep the door open as much as a user wants by using friction between the floor surface and the bottom of the door stopper. According to a shape of the door stopper, the door stoppers may be classified into a wedge-shaped door stopper and a horseshoe-shaped door stopper. The wedge-shaped door stopper has an elongated top surface with a slope. Wedge-shaped door stoppers are usually placed between a bottom of the door and a floor surface such that the bottom of the door is caught in the top surface. The force of friction between the bottom of the door and the floor surface prevents the door from being swung. On the other hand, the horseshoe-shaped door stoppers usually include a supporting plate to be fixed to a lower edge of the door, a horseshoe-shaped swing arm, one end of which is connected to the supporting plate by a pin such that the swing arm can be swung, and a rubber tip is connected to the other end of the swing arm. The horseshoe-shaped door stoppers prevent the door from being closed by moving the swing arm downward such that the rubber tip touches the floor surface. When the horseshoe-shaped stoppers are not in use, the swing arms of the horseshoe-shaped stoppers are moved upward and remain in that condition.

Related prior art: Korean Patent No. 20-0447799 Y1 (Publication date: Feb. 22, 2010).

### BRIEF SUMMARY

Embodiments of the present invention include a door stopper that comprises a lower member including soft elastic material and an upper member including a rigid material with high hardness. The lower member including soft elastic material prevents, when the door stopper is used to fix a door to an intended spot, the bottom surface of the door stopper from slipping over a floor surface, and allows the bottom surface to contact the floor surface firmly with high friction. The upper member including rigid material with high hardness may be removably coupled to a top surface of the lower member and include a smooth, sloped top surface. When the door stopper is in use between the floor surface and the bottom of the door and a force is applied to the door in the direction that the door is closed, the bottom of the door glides up against the slope of the top surface of the upper member. The top surface of the lower member may include an upward slope from one end to the other end of the top surface of the lower member, and the top surface of the upper member may include an upward slope such that the upward slope of the top surface corresponds to the upward slope of the top surface of the lower member.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a cross-sectional view of a typical wedge-shaped door stopper in use according to the prior art

FIG. 2 illustrates a perspective view of a door stopper according to a first embodiment of the present invention.

FIG. 3 illustrates a plane view of the door stopper according to the first embodiment of the present invention.

FIG. 4 illustrates a side view of the door stopper according to the first embodiment of the present invention.

FIG. 5 illustrates a cross-sectional view of the door stopper according to the first embodiment of the present invention.

FIG. 6 illustrates a side view of the door stopper in use according to the first embodiment of the present invention.

FIG. 7 illustrates a side view of a door stopper according to a second embodiment of the present invention.

FIG. 8 illustrates a side view of a door stopper according to a third embodiment of the present invention.

FIG. 9 illustrates a side view of a door stopper according to a fourth embodiment of the present invention.

### DETAILED DESCRIPTION

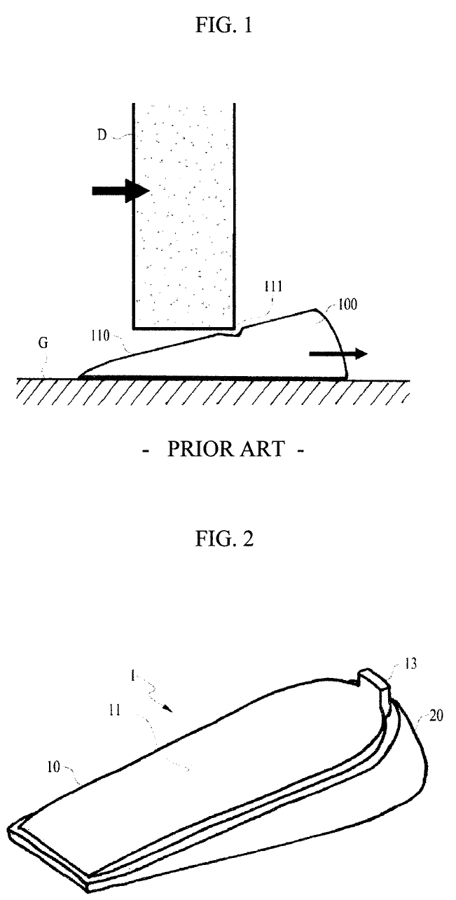

FIG. 1 illustrates a cross-sectional view of a typical wedge-shaped door stopper in use according to a prior art. The typical wedge-shaped door stopper may be integratedly made of one material such as wood, rubber, or plastic. A bottom surface of the existing wedge-shaped door stopper has been manufactured of flexible materials with strong force of friction, for example, rubber to prevent the door stopper from slipping over a floor surface easily. However, in that case, the friction between a bottom of the door and a top surface of the door stopper also gets much stronger at the same time. Thus, there is a problem that, when a force is applied to the door in the direction of being closed, the top surface of the door stopper is held by the bottom of the door, and the door stopper and the door slip over together in the direction of the door being closed.

In particular, when the door stopper is in use on a smooth, slippery floor surface, this problem occurs frequently. To address this problem, a user usually has to hold down the door stopper with one foot and pull the door in attempt to put the door stopper deeper into a space between the bottom of the door and the floor surface. However, such attempts cause a damage on the top surface of the door stopper because pressure from the edge of the bottom of the door is applied to the top surface of the door stopper when the door stopper contacts the bottom of the door. This damage increases the force of friction between the bottom of the door and the top surface of the door stopper, and causes the door stopper to fail to stop the swinging of the door and thus slip over the floor surface more easily in the next use.

In addition, although a new door stopper has relatively strong friction against the bottom surface of the door stopper, as the door stopper is repetitively used, the friction decreases by gradual wearing-out of the bottom surface of the door stopper. Therefore, the function of the door stopper to hinder the door from closing or swinging would get weaker gradually, and the problem of slipping over the floor surface gets even worse.

As a result, as the user repeats to use the door stopper, the friction applied to the top surface of the door stopper increases gradually and the friction applied to the bottom surface of the door stopper decreases gradually. Accordingly, the function of the door stopper to prevent the door from closing the door would decline.

The object of the present invention is to solve those problems described above. The object of the present invention is to provide a door stopper that minimizes the friction against the top surface of the door stopper that contacts the bottom of the door and maximizes the friction against the bottom surface of the door stopper to be contacted to the floor surface, such that the door stopper is not slipped over the floor surface easily and effectively fix the door.

Another object of the present invention is to provide a method for replacing easily only a part of the door stopper that needs to be replaced where the iterative usages of the door stopper lead to damages, for example, scratches on the top surface of the door stopper or wearing-out of the bottom surface of the door stopper.

In order to achieve the objects described above, the present invention provides a door stopper comprising: a lower member including soft elastic material that, when the door stopper is used to fix a door to an intended spot, prevents a bottom surface of the door stopper from slipping along over a floor surface and allows the bottom surface to contact the floor surface firmly with high friction; and an upper member including rigid material with high hardness that is removably coupled to a top surface of the lower member and includes a smooth, sloped top surface, wherein when the door stopper is used between the floor surface and a bottom of the door and a force is applied to the door in the direction that the door is closed, the bottom of the door glides up against a slope of the top surface of the upper member.

The top surface of the lower member may include an upward slope from one end to the other end of the top surface, and the top surface of the upper member may include an upward slope such that the upward slope of the top surface corresponds to the upward slope of the top surface of the lower member.

The top surface of the lower member may include a level surface, and the upper member includes a wedge-shaped body with a sloped top surface.

The lower member may include a plurality of protrusions that are spaced from each other and arranged in wide direction of the lower member, and the upper member may include a wedge-shaped body with a sloped top surface.

A highest end of the top surface of the upper member may include a vertical protrusion to prevent the door from slipping over the door stopper.

The upper member may include stainless steel or engineering plastic with high hardness, and the lower member may include natural rubber or synthetic rubber.

A plurality of combining projections may be disposed on the bottom surface of the upper member at regular intervals, and a plurality of combining grooves may be disposed on the top surface of the lower member and correspond to the plurality of combining projections on the bottom surface of the upper member, respectively. A plurality of combining grooves may be disposed on the top surface of the lower member at regular intervals and correspond to the plurality of combining projections on the bottom surface of the upper member, respectively.

A waterproof coating may be applied onto the top surface of the upper member. A water repellant coating may be applied onto the top surface of the upper member.

The present invention allows the door stopper to hold the door effectively by forming the top surface of the upper member smooth to minimize the friction between the door and the door stopper and to maximize the friction between the bottom surface of the lower member and the floor surface to prevent the door stopper from slipping over the floor surface. In addition, the upper member is removably coupled to the lower member such that the user can disassemble the upper member from the lower member. This structure makes it possible to replace easily only a part that was worn out or got damaged in the door stopper.

The protrusion positioned at the highest end of the top surface of the upper member prevents the door from slipping over the floor surface where there is a large gap between the bottom of the door and the floor surface. The waterproof coating or water repellant coating on the top surface of the upper member prevents the increase of friction against the top surface of the upper member.

Followings are detailed explanations using the presented drawings and desired embodiments of the door stopper according to the present invention. The phraseology or terminology used herein is for the purpose of description and not limitation, such that the phraseology or terminology of the present specification is to be interpreted by the skilled person in the art. The embodiments and the constitution of the drawings illustrate all aspects of the technical principle of this invention, not represent them. It should be understood that other applicable modifications of the present invention may exist.

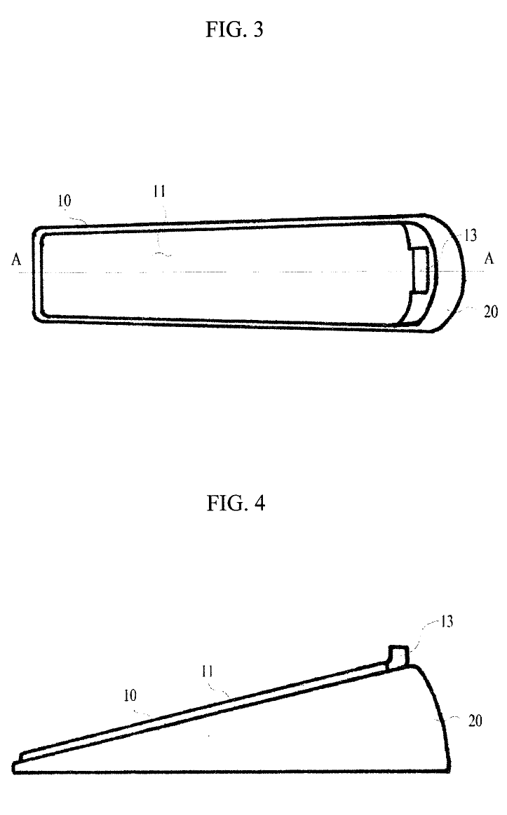

FIG. 2 illustrates a perspective view of a door stopper according to a first embodiment of the present invention, and FIG. 3 illustrates a plane view of the door stopper of FIG. 2, and FIG. 4 illustrates a side view of the door stopper of FIG. 2.

In the first embodiment of the present invention, the door stopper 1 includes an upper member 10 of a rigid material having high hardness and a lower member 20 of soft elastic material. The top surface of the lower member 20 forms an upward slope from one end of the top surface of the lower member 20. The bottom surface of the lower member 20 may be flat so that it firmly contacts the floor surface G. This lower member 20 may be made of a natural or synthetic rubber material to maximize the friction between the bottom of the door stopper 1 and the floor surface G.

The top surface 11 of the upper member 10 also forms an upward slope from one end of the top surface 11. The upward slope from one end of the top surface 11 corresponds to the top surface of the lower member 20 where the upper member 10 is installed on the top surface of the lower member 20.

A gradient of the slope of the top surface 11 of the upper member 10 is 10° ˜30°. The top surface 11 of the upper member 10 may be smooth and slippery to minimize the friction against the bottom of the door D.

In addition, a vertical protrusion 13 is formed at the highest end of the top surface 11 of the upper member 10 to prevent the door from slipping over the door stopper where a strong force of closing the door is applied because there is a large gap between the floor surface G and the bottom of the door D or a hinge of the door is loose.

This upper member 10 may be made of stainless steel or engineering plastic with high hardness. A waterproof coating or water repellant coating applied to the top surface 11 of the upper member 10 suppresses the increase of friction against the top surface 11 of the upper member 10 due to moisture on the top surface 11.

The door stopper 1 in use is placed between the floor surface G and the bottom of the door D. When a force is applied to the door in the direction of being closed, the bottom of the door D glides up against the upward slope of the top surface 11 of the upper member 10 for a certain distance.

The top surface 11 of the upper member 10 to be contacted to the bottom of the door may be formed smooth to minimize the friction between the door D and the door stopper 1 and to maximize the friction between the bottom surface of the lower member 20 and the floor surface G to prevent the door stopper 1 from slipping over the floor surface G.

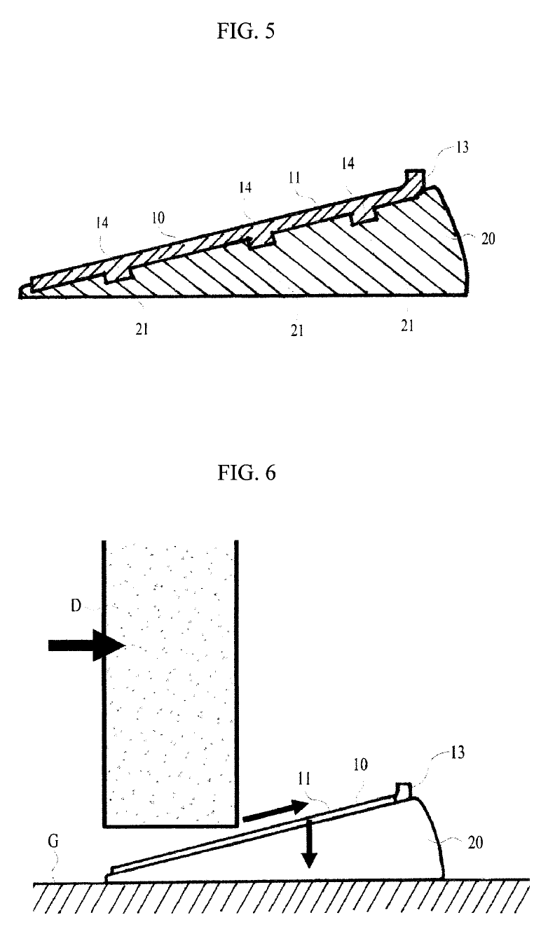

FIG. 5 illustrates a cross sectional view taken along a broken line A-A of FIG. 3. A plurality of projections 14 may be formed on the bottom surface of the upper member 10. The same number of combining grooves 21 to be inserted to by those projections 14 are formed on the top surface of the lower member 20 to assemble the upper member 10 and the lower member 20. Alternatively, a plurality of projections may be formed on the top surface of the lower member 20 at regular intervals, and a plurality of combining grooves 21, the shape of which correspond to that of the plurality of projections, may be formed on the bottom surface of the upper member 10 to assemble the upper member 10 and the lower member 20.

The upper member 10 of a rigid material with high hardness is removably coupled to the lower member 20 of a soft elastic material. Such constitutions permit to replace easily only a part of the door stopper 1 that needs to be replaced, where the iterative usages of the door stopper 1 lead to damages, for example, scratches on the top surface 11 of the door stopper 1 or wearing-out of the bottom surface of the door stopper 1. Therefore, the user can reduce a cost for the door stopper 1 because the user only has to pay for the damaged part of the stopper 1 that needs to be replaced.

FIG. 6 illustrates a side view of the door stopper in use according to the first embodiment of the present invention. When a horizontal force is applied to the door D in the direction of being closed, the bottom of the door D glides up against the slope of the top surface 11 of the upper member 10 for a short distance because of the hard, slippery and sloped top surface 11 of the upper member 10. This upward gliding movement of the door D on the slope of the top surface 11 of the upper member 10 provides the vertical downward pressure to the door stopper 1 that accordingly increases the friction between the bottom surface of the lower member 20 and the floor surface G. At the same time, the lower member 20 is made of material having very strong friction such as rubber that helps the door stopper 1 not being slipped over the floor surface G and effectively stop the door G from being closed.

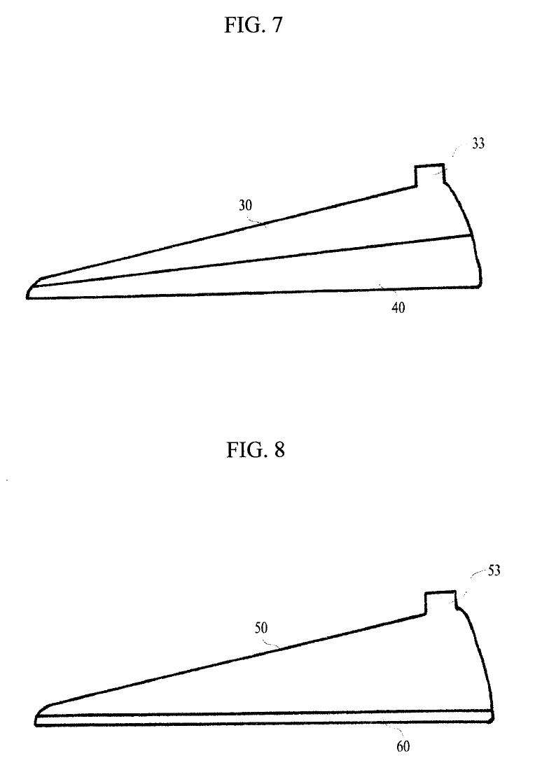

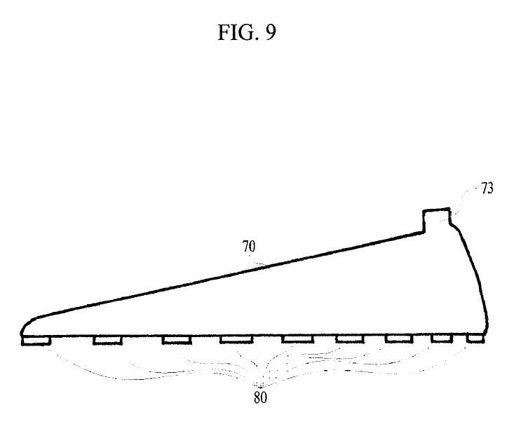

FIG. 7 illustrates a side view of a door stopper according to a second embodiment of the present invention. FIG. 8 illustrates a side view of a door stopper according to a third embodiment of the present invention. FIG. 9 illustrates a side view of a door stopper according to a fourth embodiment of the present invention.

As shown in FIG. 7, a top surface of a lower member 40 forms an upward slope from one end of the top surface. Alternatively, as shown in FIG. 8, a top surface of a lower member 60 forms a horizontal flat shape. In that case, the upper members 30, 50 in FIGS. 7 and 8 is formed to be thicker such that vertical downward pressure can be effectively applied to the door stopper 1 while the bottom of the door glides up along the sloped top surface of the upper members 30, 50. This structure prevents the door stopper 1 from slipping over the floor surface G. Also, a vertical protrusion 33, 53 for holding the door may be formed at a highest end of the sloped top surface of the upper members 30, 50 in FIGS. 7 and 8.

Referring to FIG. 9, a lower member 80 may be formed as a plurality of projections on the bottom surface of the upper member 70 and the plurality of projections 80 may be spaced from each other at regular intervals and arranged in wide direction of the lower member. The top surface of the upper member 70 may include an upward slope. The gradient of the slope of the top surface of the upper member 70 is within 10°˜30°. A vertical protrusion 73 for holding the door may be formed at a highest end of the sloped top surface of the upper member 70 in FIG. 9.

The present invention described above is not limited to such adaptations and modifications, and the drawings. It is obvious and understandable that the present invention may be modified with variety of other shapes and methods within a gist of the present invention.

### REFERENCE SIGNS OF THE DRAWINGS

1: door stopper
10: upper member
11: top surface of the upper member
13: protrusion on the top surface of the upper member
14: projections on the bottom surface of the upper member
20: lower member
21: grooves on the top surface of the lower member
30, 50, 70: variations of upper member
33, 53, 73: variations of vertical protrusion on the top surface of the upper member
40, 60, 80: variations of lower member
D: door
G: floor surface

What claimed is:

1. A door stopper comprising:
a lower member including soft elastic material that, when the door stopper is used to fix a door to an intended spot, prevents a bottom surface of the door stopper from slipping along over a floor surface and allows the bottom surface to contact the floor surface firmly with high friction; and
an upper member including rigid material with high hardness that is removably coupled to a top surface of the lower member and includes a smooth, sloped top surface,
wherein when the door stopper is used between the floor surface and a bottom of the door and a force is applied to the door in the direction that the door is closed, the bottom of the door glides up against a slope of the top surface of the upper member.

2. The door stopper according to claim 1, wherein the top surface of the lower member includes an upward slope from one end to the other end of the top surface, and
the top surface of the upper member includes an upward slope such that the upward slope of the top surface corresponding to the upward slope of the top surface of the lower member.

3. The door stopper according to claim 1, wherein the top surface of the lower member is level, and
the upper member include a wedge-shaped body with a sloped top surface.

4. The door stopper according to claim 1, wherein the bottom surface of the lower member includes a plurality of protrusions that are spaced from each other and arranged in wide direction of the lower member, and

5. The door stopper according to claim 1, wherein a highest end of the top surface of the upper member includes a vertical protrusion to prevent the door from slipping over the door stopper.

6. The door stopper according to claim 1, wherein the upper member includes stainless steel or engineering plastic with high hardness, and
the lower member includes natural rubber or synthetic rubber.

7. The door stopper according to claim 1, wherein a plurality of combining projections are disposed on the bottom surface of the upper member, and
a plurality of combining grooves are disposed on the top surface of the lower member and correspond to the plurality of combining projections on the bottom surface of the upper member, respectively.

8. The door stopper according to claim 1, wherein a plurality of combining grooves are disposed on the bottom surface of the upper member, and
a plurality of combining projections are disposed on the top surface of the lower member and correspond to the plurality of combining grooves on the bottom surface of the upper member, respectively.

9. The door stopper according to claim 1, wherein a waterproof coating is applied onto the top surface of the upper member.

10. The door stopper according to claim 1, wherein a water repellant coating is applied onto the top surface of the upper member.
